(19) United States
(12) Patent Application Publication
(10) Pub. No.: US 2026/0239294 A1
(43) Pub. Date: Aug. 13, 2026

(54) TECHNOLOGIES FOR PAGING IN WIRELESS NETWORKS

(71) Applicant: Apple Inc., Cupertino, CA (US)

(72) Inventors: Naveen Kumar R. Palle Venkata, San Diego, CA (US); Yuqin Chen, Beijing (CN); Alexander Sirotkin, Tel Aviv (IL); Haijing Hu, Los Gatos, CA (US); Ping-Heng Kuo, London (GB); Peng Cheng, Beijing (CN); Fangli Xu, Beijing (CN); Zhibin Wu, Los Altos, CA (US); Ralf Rossbach, Munich (DE); Vivek G. Gupta, San Jose, CA (US)

(73) Assignee: Apple Inc., Cupertino, CA (US)

(21) Appl. No.: 19/155,936

(22) PCT Filed: Feb. 13, 2023
(86) PCT No.: PCT/CN2023/075681

§ 371 Date: Aug. 12, 2025

(51) Int. Cl. H04W 68/02; H04W 52/02; H04W 76/28

(52) U.S. Cl. CPC H04W 68/02; H04W 52/0229; H04W 76/28

(57) ABSTRACT

The present application relates to devices and components including apparatus, systems, and methods for paging inactive devices in wireless networks.

### TECHNICAL FIELD

This application relates generally to communication networks and, in particular, to technologies for paging user equipment in wireless networks.

### BACKGROUND

Third Generation Partnership Project (3GPP) Technical Specifications (TSs) define paging mechanisms that allow a network to reach user equipment (UE) that are in radio resource control (RRC) inactive or idle states.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates a paging diagram in accordance with some embodiments.

FIG. 4 illustrates a paging diagram in accordance with some embodiments.

FIG. 5 illustrates paging configurations in accordance with some embodiments.

FIG. 6 illustrates an overlapped paging hyperframe in accordance with some embodiments.

FIG. 7 illustrates another overlapped paging hyperframe in accordance with some embodiments.

FIG. 8 illustrates an operational flow/algorithmic structure in accordance with some embodiments.

FIG. 9 illustrates an operational flow/algorithmic structure in accordance with some embodiments.

FIG. 10 illustrates a user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

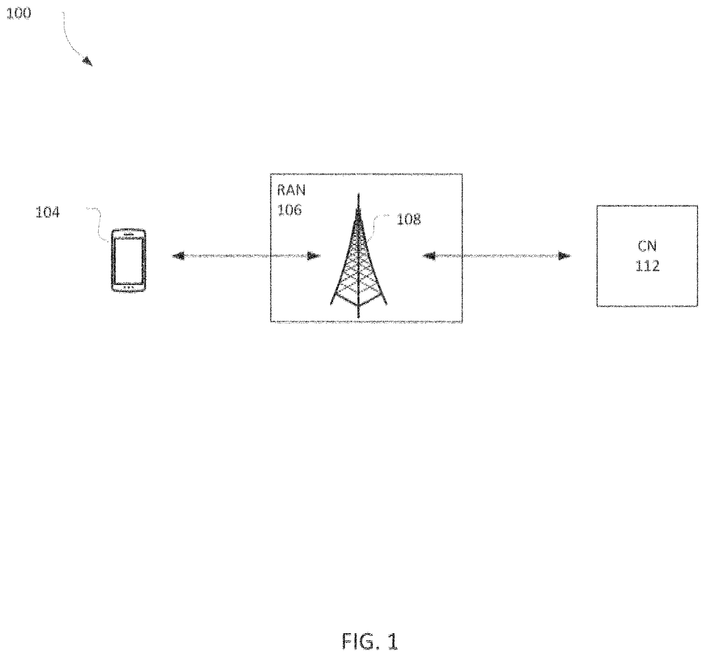

FIG. 1 illustrates a network environment 100 in accordance with some embodiments. The network environment 100 may include a UE 104, a radio access network (RAN) 106 including a base station 108, and a core network (CN) 112. The RAN 106 may also be referred to as a next generation RAN (NG RAN) and the CN 112 may also be referred to as a Fifth Generation Core (5GC). The base station 108 may provide one or more wireless access cells through which the UE 104 may communicate with the RAN 108. The base station 108 may provide an air interface compatible with 3GPP technical specifications, such as those that define Fifth Generation (5G) new radio (NR) or later system standards. The base station 108 may provide the UE 104 access to other networks, for example, the CN 112, a data network, etc. Depending on the technology of the RAN 106 and the CN 112, the base station 108 may be referred to as an eNB, gNB, an ng-NB, etc.

The base station 108 may handle various functions related to managing the access stratum for the UE 104. These functions may include inter-cell radio resource management (RRM), radio bearer control, connection mobility control, radio admission control, measurement configuration and provision, and uplink/downlink resource allocation. The CN 112 may have a service-based architecture with network functions that may operate independently from one another. These network functions may include an access and mobility management function (AMF) to provide non-access stratum (NAS) security and idle state mobility handling; a user plane function (UPF) to provide mobility anchoring and protocol data unit (PDU) handling; and a session management function (SMF) to provide Internet protocol (IP) address allocation and PDU session control.

The UE 104 may be configured to operate in one of the following protocol states: an RRC idle state; an RRC inactive state; or an RRC connected state. When the UE 104 is in an RRC connected state, the UE 104 may have connections established with both the base station 108 and the CN 112 and may be capable of uplink and downlink unicast data transfer. To reach the UE 104 when it is in the RRC idle state or the RRC inactive state, the CN 112 or base station 108 may transmit paging messages to the UE 104. The paging may be initiated by the RAN 106, referred to as RAN paging, or by the CN 112, referred to as CN paging. Paging operations of the RRC idle state include CN paging for mobile-terminated data and discontinuous reception (DRX) for CN paging, which is configured by NAS. Paging operations of the RRC inactive state include RAN paging and DRX for RAN paging, which is configured by the RAN 106.

Paging DRX has been defined to avoid requiring the UE 104 to continuously monitor the paging channels and, therefore, reduce battery consumption by the UE 104. Paging DRX allows the UE 104, while in RRC idle or inactive states, to only monitor the paging channel during one or more defined paging occasions (POs) per DRX cycle. UE-specific paging DRX cycles may be configured by NAS signaling for CN paging and by RRC signaling for RAN paging.

Extended DRX (eDRX) has been defined with larger DRX cycles to further reduce UE battery consumption. This may be especially useful for reduced capability UEs that may have constraints on battery size due to smaller form factors.

Release 17 of the 3GPP TSs define eDRX as follows. The eDRX configuration for RAN paging may be decided and configured by an NG RAN. In RRC inactive, a UE may monitor both RAN and CN paging. For RRC idle, the eDRX configuration for CN paging is configured by upper layers using, e.g., NAS signaling. In RRC idle, the UE 104 may only monitor for CN paging. Information on whether eDRX for CN paging and RAN paging is allowed on a particular cell may be provided separately in system information.

Release 17 defines the maximum value of the eDRX cycle to be 10,485.76 seconds (2.91 hours) for RRC idle and 10.24 seconds for RRC inactive, and define the minimum value of the DRX cycle to be 2.56 seconds for both RRC idle and RRC inactive.

To facilitate management of longer DRX cycles, a hyper system frame number (H-SFN), paging hyperframe (PH), and paging time window (PTW) are defined. The H-SFN is broadcast by the base station 108 and increments by one when a system frame number (SFN) wraps around. The PH refers to the H-SFN in which the UE 104 is to start monitoring paging DRX during a PTW used in RRC idle. The PH and PTW may be determined based on a formula that is known by the AMF, UE 104 and the RAN 106. The H-SFN, PH, and PTW may be used if the eDRX cycle is greater than 10.24 seconds. When the RRC idle eDRX cycle is longer than a system information modification period, the UE 104 may verify that the stored system information remains valid before establishing an RRC connection.

Support of eDRX inactive may be optional for both the UE 104 and the network. If the UE 104 supports eDRX inactive, it should also support eDRX idle.

Release 18 of the 3GPP TSs will provide various enhancements to eDRX operation. One enhancement may include extending the eDRX cycle in inactive to 10,485.76 seconds (2.91 hours). When the UE 104 is in the RRC inactive state and is configured with a long eDRX RAN paging cycle, a UPF of the CN 106 may perform data buffering and only push down data when the PTW arrives.

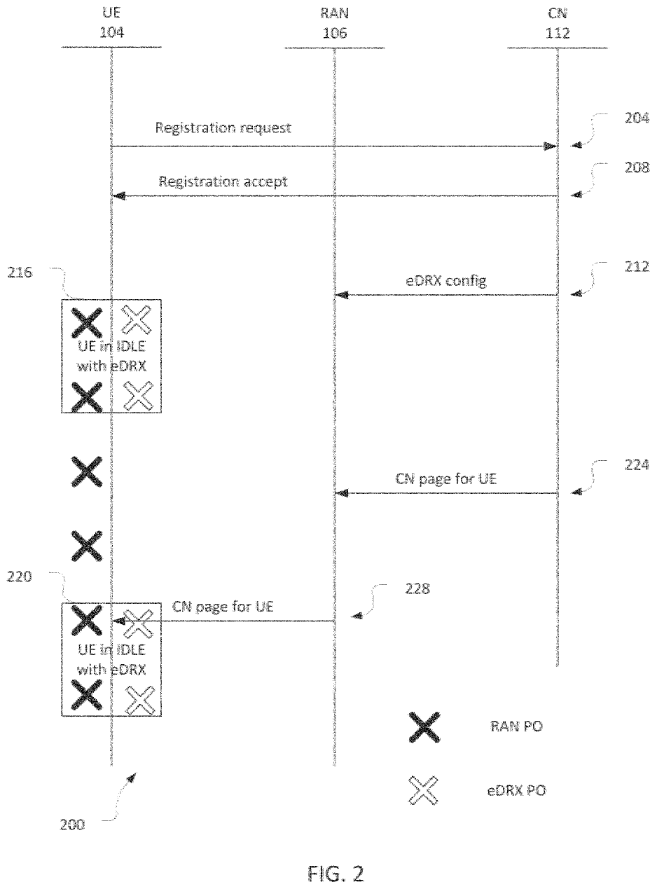

FIG. 2 is a signaling diagram 200 for a paging operation in accordance with some embodiments. The signaling diagram 200 may include signals and operations performed by the UE 104, the RAN 106, and the CN 112.

At 204, the UE 104 may transmit a registration request message to the CN 112. The registration request message may include an indication of UE capabilities and support for eDRX.

At 208, the CN 112 may respond with a registration accept message. The registration accept message may include an eDRX configuration generated by the CN 112 for the UE 104.

At 212, the CN 112 may also transmit the eDRX configuration to the RAN 106.

The eDRX configuration may configure the UE 104 to periodically wake up to monitor for paging messages. For example, the eDRX configuration may configure the UE 104 to monitor for paging messages at 216 and 220 while in an idle state.

The RAN POs of FIG. 2 illustrate the POs in which the UE 104 would wake up to monitor for paging messages if the UE 104 was not in eDRX. The eDRX POs illustrate the POs in which the UE 104 would wake up to monitor for paging messages while in eDRX.

At 224, the CN 112 may provide, to the RAN 106, a CN page for the UE 104. The RAN 106 may withhold delivery of the CN page until 228, which corresponds to the next eDRX PO in 220.

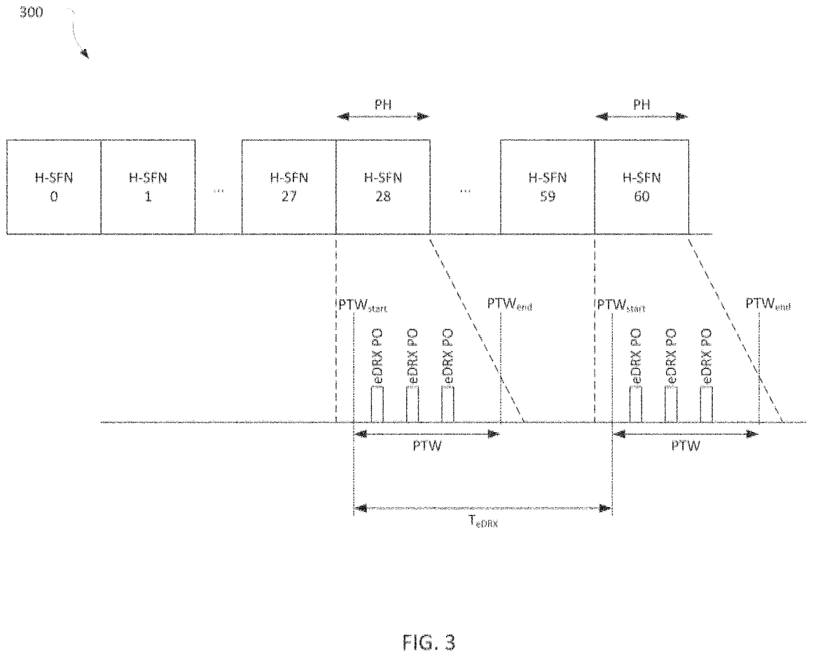

FIG. 3 illustrates a paging diagram 300 that may be used in longer eDRX cycles in accordance with some embodiments. As shown, the paging diagram 300 includes H-SFN 0-H-SFN 60, with H-SFN 28 and H-SFN 60 being designated as the PHs.

In each PH, the UE 104 may be configured to monitor eDRX POs within a PTW. An eDRX PO may correspond to an SFN that the UE 104 is to monitor. The PTW may be UE-specific and may be determined by the PH, a starting position within the PH (PTWₛₜₐᵣₜ), and an ending position within the PH (PTW_{end}). Starting positions of consecutive PTWs may be separated by an eDRX cycle length (T_{eDRX}).

The RAN 106 may configure the PH/PTW for RAN paging, while the CN 112 configures the PH/PTW for CN paging. The RAN PTW length may be different from the CN PTW length. When RAN PH and the CN PH coincide in the same PH, the PTW starting locations may be the same.

Given that the CN and RAN PTW/PH may be configured differently, and the RAN PTW/PH is solely configured by the RAN 106, there may be configurations in which no RAN PHs overlap with CN PHs. This may be the case even if the periodicity is the same for both RAN eDRX and CN eDRX. If this configuration occurs, and the RAN 106 and CN 112 go out-of-sync on the UE context, the CN 112 may not be able to reach the UE 104. Thus, embodiments may provide for fail-safe procedures for RAN paging of UEs in inactive state when the eDRX cycle is greater than 10.24 seconds. These procedures may provide power-efficient RAN PTW/PH operation and ensure the CN paging is reachable to the inactive UE 104, even when the CN 112 assumes the inactive UE 104 is in an idle state, which may be the assumption if the CN 112 does not receive signaling for a certain period of time. Additional embodiments describe general operation inside of and outside of the PTW and RAN mechanisms for paging distribution for inactive UEs.

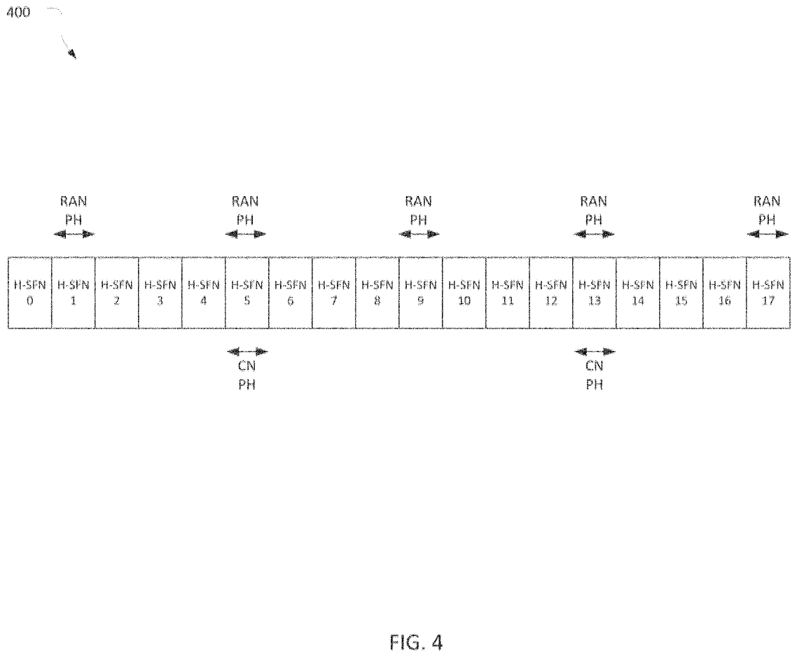

FIG. 4 illustrates paging configurations 400 in accordance with some embodiments. The paging configurations 400 may ensure at least some overlap between the RAN PH, provided by RAN eDRX configuration, and the CN PH, provided by the CN eDRX configuration.

As shown, the RAN PH may occur every fourth H-SFN, e.g., at H-SFN 1, H-SFN 5, H-SFN 9, H-SFN 13, and H-SFN 17, while the CN PH occurs every eighth H-SFN, for example, H-SFN 5 and H-SFN 13. Thus, a RAN PH overlaps with a CN PH at both H-SFN 5 and H-SFN 13.

In some embodiments, the RAN eDRX cycle may be smaller or equal to the CN eDRX cycle when both cycles are greater than 10.24 seconds and, therefore, have PTW/PH configured. This may help to ensure that CN pages to the UE 104 are not lost during a PTW of the CN 112. To ensure this relationship, the RAN 106 may use the paging configuration from the CN 112 to select the possible RAN eDRX cycles. The RAN 106 may receive the paging configuration from the CN 112 in a UE paging information (UE-PAGING-INFORMATION) information element (IE).

To ensure the overlap and the eDRX cycle relationships described above, the RAN 106 may generate the RAN eDRX configuration such that the PH for RAN is the H-SFN satisfying H-SFN mod T_{eDRX_RAN}=(UE_{ID_H} mod T_{eDRX_RAN}), where T_{eDRX_RAN} is UE-specific eDRX cycle of the RAN eDRX configuration in hyperframes and UE_{ID_H} is a predetermined number of most significant bits of a hashed identifier of the UE. In some embodiments, the UE_{ID_H} includes the 13 most significant bits of the hashed UE ID and T_{eDRX_RAN} may be configured by RAN 106. As discussed above, T_{eDRX_RAN} may configured with a value lower than or equal to the UE-specific eDRX cycle of the CN eDRX configuration (T_{eDRX_CN}). In some embodiments, both T_{eDRX_RAN} and T_{eDRX_CN} can take a value from {2, 4, 8, 16, 32, 64, 128, 256, 512, and 1024} hyperframes. In the paging configuration 400, the T_{eDRX_RAN}=4 and the T_{eDRX_CN}=8.

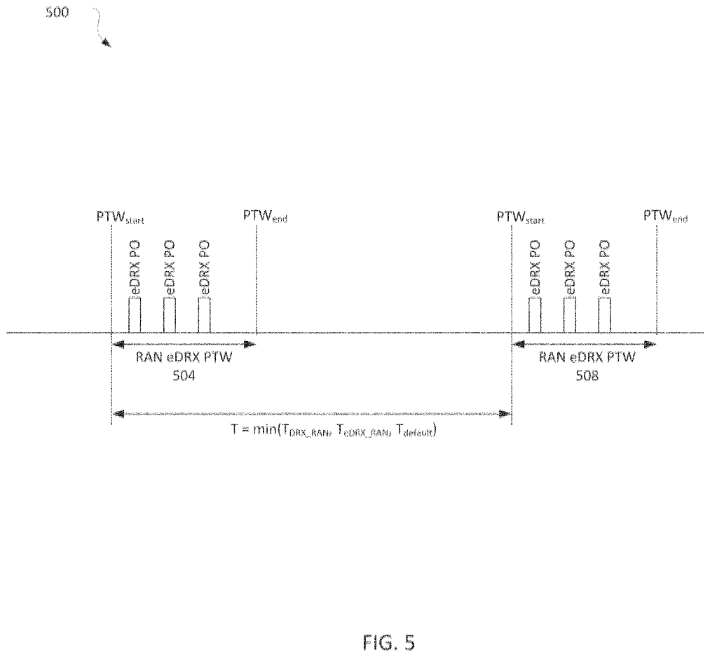

FIG. 5 illustrates a paging diagram 500 in accordance with some embodiments. The paging diagram 500 may facilitate discussion of operation inside and outside of RAN eDRX PTWs 504 and 508.

In long eDRX cycles, the UE 104 may be mobile in an inactive state and could be in different cells during different PTWs. Some cells may support updated eDRX operation (e.g., Release 18 eDRX operation) while other cells may not. Some cells may even be legacy cells that do not support a latest 3GPP release. Thus, in some embodiments, the UE 104 may be configured to use a legacy operation when operating in a cell that does not support updated eDRX operation. To facilitate this operation, the UE 104 may determine the paging cycle (T), which defines the distance between the starting point of consecutive paging cycles (e.g., RAN eDRX PTW 504 and RAN eDRX PTW 508), is the shortest of: a UE-specific DRX value (T_{DRX_RAN} or T_{DRX_CN}) if configured by upper layers; T_{eDRX_RAN}; and a default DRX value (T_{Default}) broadcast in system information.

In some embodiments, the UE 104 may follow T_{eDRX_RAN} even if a network does not support updated eDRX operation. Additionally/alternatively, the UE 104 may follow T_{eDRX_RAN} only if the network supports R17 eDRX features.

Outside of the PTWs, it may not be critical for the UE 104 to follow system information changes. Further, since the UE 104 is following the RAN eDRX cycle within the PTW, which is shorter or equal to the CN eDRX cycle, the UE 104 will be reachable if needed. Thus, in some embodiments, the UE 104 may be configured to not monitor for RAN paging outside of the RAN eDRX PTWs.

As briefly discussed above, in an overlapped PH, the RAN PTW may be timed to start with the CN PTW. However, each PTW may have different lengths. Thus, the RAN PTW may be longer or shorter than the CN PTW. Paging operation of the UE 104 may be described as follows with respect to these scenarios.

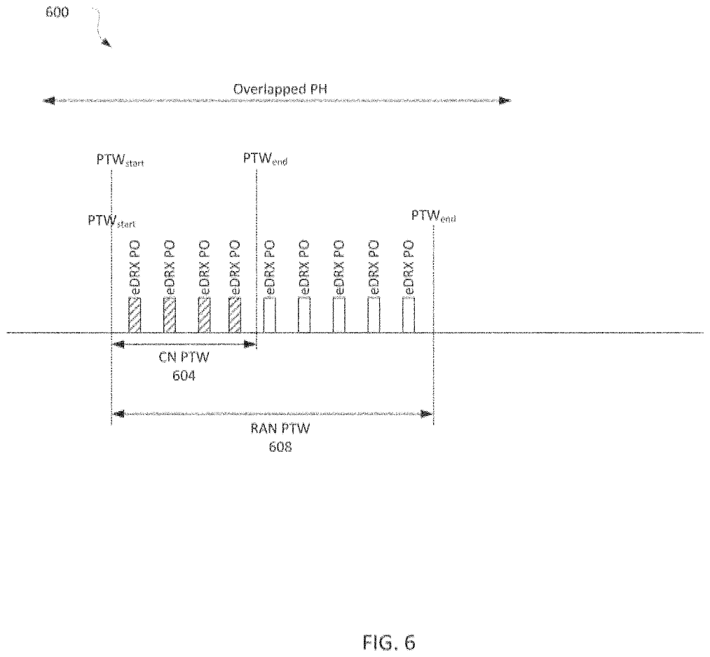

FIG. 6 illustrates an overlapped PH 600 in accordance with some embodiments. The overlapped PH 600 may include a CN PTW 604 and a RAN PTW 608. The CN PTW 604 may include a plurality of CN eDRX POs and the RAN PTW 608 may include a plurality of RAN eDRX POs. The CN PTW 604 and the RAN PTW 608 may start at the same time, but the CN PTW 604 may be shorter than the RAN PTW 608 in this embodiment. One or more of the following three options may be considered in this scenario.

In a first option, the UE 104 may monitor the RAN eDRX POs in the RAN PTW 608 and may monitor the CN eDRX POs in the CN PTW 604. This option may be useful for detecting when the RAN 106 is out of synchronization with the CN 112, although it may also be associated with a higher power consumption during the portion in which the CN PTW 604 overlaps with the RAN PTW 608.

In a first sub-option of the first option, the UE 104 uses an index (i_s) for every PO. The index (i_s) may indicate an index of a PO and may be determined by i_s=floor (UE_ID/N) mod Ns, where N is number of total paging frames in a paging cycle and Ns is a number of POs for a paging frame. The index (i_s) may be determined and used as described in clause 7.1 of 3GPP TS 38.304 v17.3.0 (2022-12) except as otherwise described herein. In a second sub-option of the first option, the UE 104 performs both CN and RAN PO monitoring, but from UE perspective, using the index i_s only for overlapped ones.

In a second option, the RAN configuration may ensure that the CN eDRX POs will align with the RAN eDRX POs in the overlapped section that corresponds to the CN PTW 604. The RAN 106 may ensure this happens based on receiving the CN eDRX config at, for example, message 212 of FIG. 2. The aligned CN and RAN eDRX POs are shown with the cross-hatched fill.

In a third option, the UE 104 may only monitor the RAN eDRX POs in the RAN PTW 608. The RAN eDRX POs may be monitored for both RAN pages and CN pages. The RAN 106 may buffer the CN pages and provide them within the RAN eDRX POs. In this case, the CN 112 may not know that the UE 104 is awake after the CN PTW. Thus, CN pages may only be transmitted in the overlapped portion.

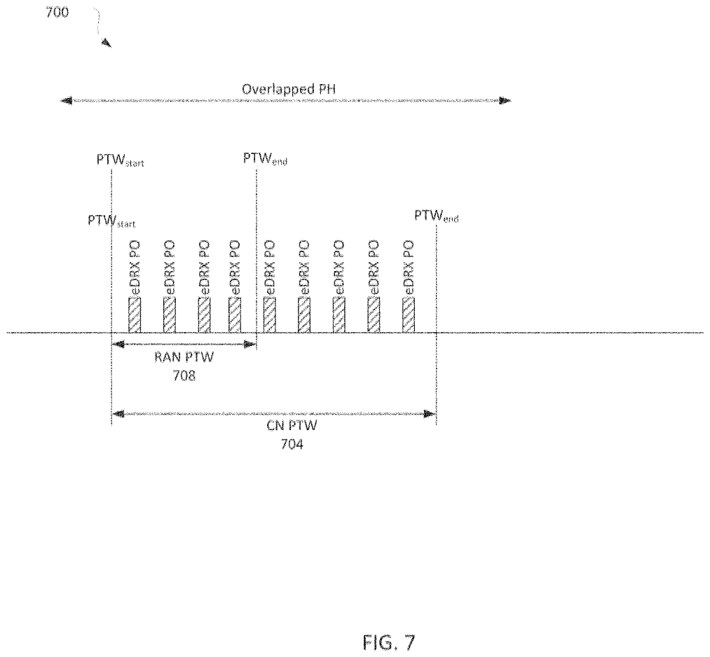

FIG. 7 illustrates an overlapped PH 700 in accordance with some embodiments. The overlapped PH 700 may include a CN PTW 704 and a RAN PTW 708. The CN PTW 704 may include a plurality of CN eDRX POs and the RAN PTW 708 may include a plurality of RAN eDRX POs. The CN PTW 704 and the RAN PTW 708 may start at the same time, but the CN PTW 704 may be longer than the RAN PTW 708 in this embodiment. One or more of the following two options may be considered in this scenario.

In a first option, the UE 104 may only monitor the RAN eDRX POs in the RAN PTW 708. The RAN eDRX POs may be monitored for both RAN pages and CN pages (as the CN eDRX POs may be aligned with the RAN eDRX POs within the RAN PTW 708). In this option, the UE 104 may not monitor the CN eDRX POs that occur in the CN PTW 704 after the RAN PTW 708.

In a second option, the UE 104 may monitor for the RAN paging in the eDRX POs of the overlapped section that corresponds to the RAN PTW 708 and may monitor for CN paging in the CN eDRX POs that occur in the CN PTW 704 after the RAN PTW 708. Thus, this option may imply that the POs to be monitored by the UE 104 are extended to the length of the CN PTW 704.

The second option may be implemented by defining PTW_{end} as the last radio frame of the PTW that has an SFN satisfying the following equation: SFN=(PTWₛₜₐᵣₜ+L*100−1) mod 1024, where, if PH has both RAN and CN PTWₛₜₐᵣₜₛ, then L is given by L=max{PTW length (in seconds) configured by upper layers; PTW length (in seconds) configured by RAN}; else, L=PTW length (in seconds) configured by RAN. The PTW length configured by upper layers may correspond to a length of the CN PTW 704, while the PTW length configured by RAN may correspond to a length of the RAN PTW 708.

In some embodiments, if both the PTW for the RAN eDRX and the PTW for the CN eDRX share the same starting point PTWₛₜₐᵣₜ (in an overlapped PH such as overlapped PH 700), PTWₛₜₐᵣₜ may be determined as follows. The PTWₛₜₐᵣₜ may be defined as the first radio frame of the PH that is part of both the RAN PTW and the CN PTW and has an SFN satisfying the following equation: SFN=128*i_{eDRX_RAN}, where i_{eDRX_RAN}=floor (UE_{ID_H}/T_{eDRX_CN}) mod 8.

More broadly, the above may be used to determine a PTWstart in an overlapping PH, but another equation may be used to determine the PTWstart in a non-overlapping PH. For example, PTWₛₜₐᵣₜ may be defined as the first radio frame of a PH that is part of a PTW and has an SFN satisfying the following equation: for the case in which RAN eDRX PH and CN eDRX PH are the same, SFN=128*i_{eDRX_RAN}, where i_{eDRX_RAN}=floor (UE_{ID_H}/T_{eDRX_CN}) mod 8; else, SFN=128*i_{eDRX_RAN}, where i_{eDRX_RAN}=floor (UE_{ID_H}/T_{eDRX_RAN}) mod 8.

In some embodiments, it may be desirable for the base station 108 to distribute the RAN PTWs configured to various UEs of a cell over time. This may avoid a number of UEs having to be paged in the same SFN. To distribute PTWₛₜₐᵣₜ for different UEs, the RAN 106 may provide RAN eDRX PTW/PH configurations that vary for each UE.

In some embodiments, the RAN 106 may have more than the eight distributions within the PH that are available for a CN PTWₛₜₐᵣₜ. For example, the RAN 106 may have 16 or 32 distributions, which may allow the RAN 106 to further distribute the occasions for different UEs that are in the inactive state with longer eDRX. In some embodiments, this may not be applicable to PHs in which the RAN PTW overlaps with CN PTW.

In some embodiments, the RAN PTWₛₜₐᵣₜ may denote a first radio frame of a PH that is part of the RAN PTW and has an SFN that satisfies the following equation: for a case in which RAN eDRX PH and CN eDRX PH are the same, SFN=128*i_{eDRX_RAN}, where i_{eDRX_RAN}=floor (UE_{ID_H}/T_{eDRX_CN}) mod 8; else, SFN=1024/N*i_{eDRX_RAN}, where i_{eDRX_RAN}=floor (UE_{ID_H}/T_{eDRX_RAN}) mod N. N may be, for example, 8, 16, or 32.

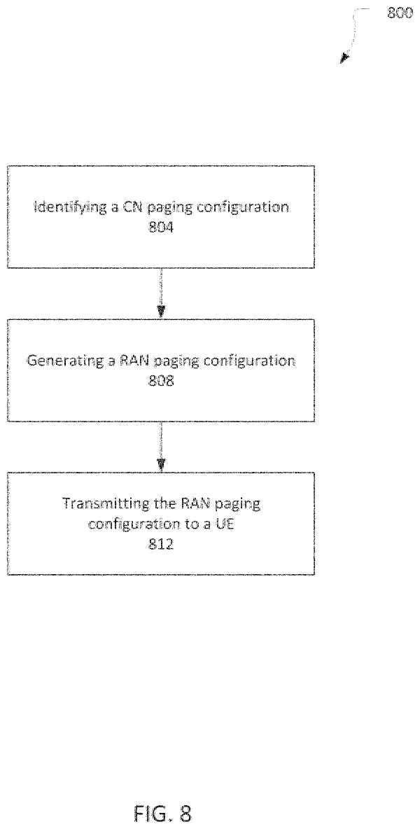

FIG. 8 illustrates an operational flow/algorithmic structure 800 for paging in accordance with some embodiments. The operational flow/algorithmic structure 800 may be implemented by a RAN device such as, for example, base station 108, network device 1100, or components therein, for example, processing circuitry 1104.

The operational flow/algorithmic structure 800 may include, at 804, identifying a CN paging configuration. The CN paging configuration may be an eDRX configuration that configures CN PH/PTW with an eDRX paging cycle greater than 10.24 seconds. In some embodiments, the CN paging configuration may be received in a UE paging information message from a core network device.

The operational flow/algorithmic structure 800 may further include, at 808, generating a RAN paging configuration. The RAN paging configuration may be an eDRX configuration that configures RAN PH/PTW with an eDRX paging cycle greater than 10.24 seconds. Aspects of the RAN paging configuration may be generated based on the CN paging configuration. For example, the RAN paging configuration may be generated with an eDRX paging cycle that is the same as or less than the eDRX paging cycle of the CN paging configuration. The RAN/CN eDRX paging cycles may be 2, 4, 8, 16, 32, 64, 128, 256, 512, or 1024 hyper-frames.

The RAN paging configuration may be generated in a manner such that at least some of the RAN PHs overlap with some CN PHs. The RAN PHs may comprise H-SFNs defined by: H-SFN mod TeDRX_RAN=(UE_{ID_H} mod T_{eDRX_RAN}), where T_{eDRX_RAN} is an eDRX cycle of the RAN paging configuration and UE_{ID_H} is a predetermined number of most significant bits of a hashed identifier of the UE. The predetermined number may be 13 in some embodiments.

The operational flow/algorithmic structure 800 may further include, at 812, transmitting the RAN paging configuration to a UE.

The CN/RAN paging configurations may provide CN/RAN PHs that overlap at a H-SFN. In the overlapping PH, each configuration may define a respective PTW. The CN/RAN PTWs may start at a same point but may end at different points. Thus, CN eDRX POs within a CN PTW may extend beyond RAN eDRX POs that are within the RAN PTW.

In the event the RAN PTW extends beyond the CN PTW, the RAN may ensure the RAN paging configuration is generated such that the RAN eDRX POs align with the CN eDRX POs in the portion of the PTWs that overlap. Further, in some embodiments, the RAN may buffer CN paging messages and provide the CN paging message to the UE in the RAN eDRX POs, which overlap with the CN eDRX POs.

In the event the CN PTW extends beyond the RAN PTW, the RAN may operate in accordance with one of two options. In a first option, the UE may only monitor the RAN eDRX POs and may not monitor the CN eDRX POSs that occur after the RAN PTW. Thus, the RAN may provide both RAN and CN paging messages during the RAN PTW and may buffer paging messages received outside of the RAN PTW. In a second option, the UE may monitor for RAN paging messages in the eDRX POs of the overlapped PTW and may monitor for CN paging messages in the CN eDRX POs that occur after the RAN PTW. Thus, the RAN may provide both RAN and CN paging messages during the RAN PTW and may provide CN paging messages received in the CN PTW outside of the RAN PTW.

In some embodiments, the RAN may generate RAN paging configurations for different UEs in a manner such that UE-specific RAN PTWs are distributed over a RAN PH. In the event the RAN PH overlaps with a CN PH, the SFN that corresponds to a start of the RAN PTW may be given by: SFN=128*i_{eDRX_RAN}, where i_{eDRX_RAN}=floor (UE_{ID_H}/T_{eDRX_CN}) mod 8, where UE_{ID_H} is a predetermined number of most significant bits of a hashed identifier of the UE and T_{eDRX_CN} is an eDRX cycle of the CN paging configuration. In the event the RAN PH does not overlap with a CN PH, the SFN that corresponds to a start of the RAN PTW may be given by: SFN=1024/N*i_{eDRX_RAN}, where i_{eDRX_RAN}=floor (UE_{ID_H}/T_{eDRX_RAN}) mod N, where UE_{ID_H} is a predetermined number of most significant bits of a hashed identifier of the UE, T_{eDRX_RAN} is an eDRX cycle of the RAN paging configuration, and N is a number of available UE-specific paging distributions (e.g., 8, 16, or 32).

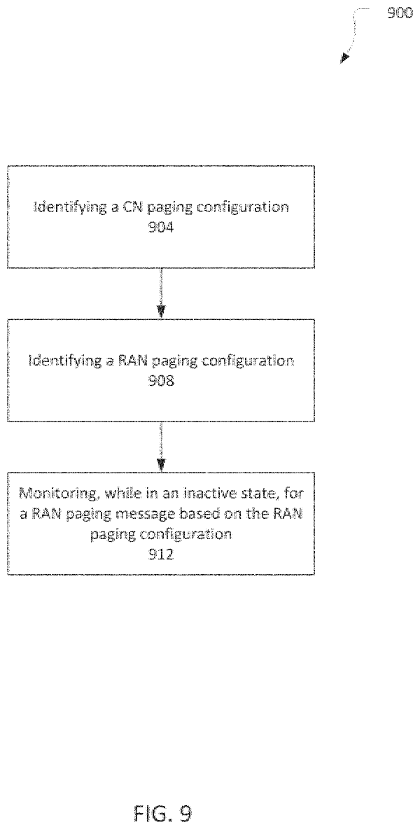

FIG. 9 illustrates an operational flow/algorithmic structure 900 for paging in accordance with some embodiments. The operational flow/algorithmic structure 800 may be implemented by a UE such as, for example, UE 104 or 1000 or components therein, for example, processing circuitry 1004.

The operational flow/algorithmic structure 900 may include, at 904, identifying a CN paging configuration. The CN paging configuration may be an eDRX configuration that configures CN PH/PTW with an eDRX paging cycle greater than 10.24 seconds. In some embodiments, the CN paging configuration may be received in a UE paging information message from a core network device.

The operational flow/algorithmic structure 900 may further include, at 908, identifying a RAN paging configuration. The RAN paging configuration may be an eDRX configuration that configures RAN PH/PTW with an eDRX paging cycle greater than 10.24 seconds. The RAN paging configuration may include an eDRX paging cycle that is the same as or less than the eDRX paging cycle of the CN paging configuration. The RAN/CN eDRX paging cycles may be 2, 4, 8, 16, 32, 64, 128, 256, 512, or 1024 hyper-frames.

The operational flow/algorithmic structure 900 may further include, at 912, monitoring for a RAN paging message based on the RAN paging configuration. The monitoring may occur while the UE is in an inactive state.

In some embodiments, the UE may identify PTWs based on the RAN paging configuration and only monitor for RAN paging messages within the PTWs. For example, the UE may monitor for RAN paging messages within the PTWs and refrain from monitoring for RAN paging messages outside of the PTWs.

As discussed above with respect to FIG. 8, in some instances the CN/RAN paging configurations may provide CN/RAN PHs that overlap at a H-SFN. In the overlapping PH, each configuration may define a respective PTW. The CN/RAN PTWs may start at a same point but may end at different points. Thus, CN eDRX POs within a CN PTW may extend beyond RAN eDRX POs that are within the RAN PTW.

In the event the RAN PTW extends beyond the CN PTW, the UE may monitor both the RAN eDRX POs and the CN eDRX POs within respective PTWs. Additionally/alternatively, the UE may only monitor the RAN eDRX POs. For example, the UE may monitor for RAN paging messages and CN paging messages in the RAN eDRX POs.

In the event the CN PTW extends beyond the RAN PTW, the UE may only monitor the RAN eDRX POs and may not monitor the CN eDRX POSs that occur after the RAN PTW. Additionally/alternatively, the UE may monitor for RAN/CN paging messages in the eDRX POs of the overlapped PTW and may monitor for CN paging messages in the CN eDRX POs that occur after the RAN PTW.

In some embodiments, if a PH has both a RAN PTW and a CN PTW, a first radio frame at an end point of the RAN PTW may be determined as a first SFN (SFN1) given by: SFN1=(PTWₛₜₐᵣₜ+L*100−1) mod 1024, wherein PTWₛₜₐᵣₜ is a second SFN (SFN2) of a second radio frame at a starting point of the RAN PTW and L is given by: L=max{a length (in seconds) of a PTW configured by upper layers (e.g., a CN PTW); a length (in seconds) of a PTW configured by RAN (e.g., the RAN PTW}. In some embodiments, if a PH does not have both a RAN PTW and a CN PTW, a first radio frame at an end point of the RAN PTW may be determined as a first SFN (SFN1) given by: SFN1=(PTWₛₜₐᵣₜ+L*100−1) mod 1024, wherein PTWₛₜₐᵣₜ is a second SFN (SFN2) of a second radio frame at a starting point of the RAN PTW and L=a length (in seconds) of a PTW configured by RAN (e.g., RAN PTW).

In some embodiments, the UE may determine the start of a RAN PTW differently depending on whether a RAN PH overlaps with a CN PH. For example, if the RAN PH overlaps with a CN PH, the SFN that corresponds to a start of the RAN PTW may be given by: SFN=128*i_{eDRX_RAN}, where i_{eDRX_RAN}=floor (UE_{ID_H}/T_{eDRX_CN}) mod 8, where UE_{ID_H} is a predetermined number of most significant bits of a hashed identifier of the UE and T_{eDRX_CN} is an eDRX cycle of the CN paging configuration. In the event the RAN PH does not overlap with a CN PH, the SFN that corresponds to a start of the RAN PTW may be given by: SFN=1024/N*i_{eDRX_RAN}, where i_{eDRX_RAN}=floor (UE_{ID_H}/T_{eDRX_RAN}) mod N, where UE_{ID_H} is a predetermined number of most significant bits of a hashed identifier of the UE, T_{eDRX_RAN} is an eDRX cycle of the RAN paging configuration, and N is a number of available UE-specific paging distributions (e.g., 8, 16, or 32).

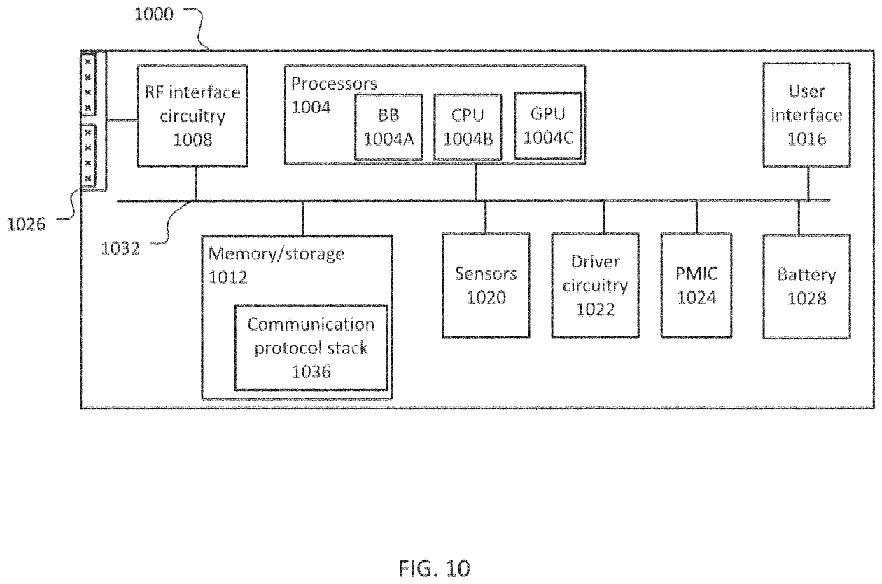

FIG. 10 illustrates a UE 1000 in accordance with some embodiments. The UE 1000 may be similar to and substantially interchangeable with UE 104 of FIG. 1.

The UE 1000 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various paging operations as described herein. For example, the processors 1004 may cause the UE to perform the operational flow/algorithmic structure 900 or any other method or process describe herein.

The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1026.

In various embodiments, the RF interface circuitry 1008 may be configured to transmit/receive signals in a manner compatible with NR access technologies.

The antenna structure 1026 may include antenna elements to convert electrical signals into radio waves to travel through the air and to convert received radio waves into electrical signals. The antenna elements may be arranged into one or more antenna panels. The antenna structure 1026 may have antenna panels that are omnidirectional, directional, or a combination thereof to enable beamforming and multiple input, multiple output communications. The antenna structure 1026 may include microstrip antennas, printed antennas fabricated on the surface of one or more printed circuit boards, patch antennas, or phased array antennas. The antenna structure 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various I/O devices that may be present within, or connected to, the UE 1000. For additional examples, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

In some embodiments, the PMIC 1024 may control, or otherwise be part of, various power saving mechanisms of the UE 1000 including DRX as discussed herein.

A battery 1028 may power the UE 1000, although in some examples the UE 1000 may be mounted deployed in a fixed location, and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

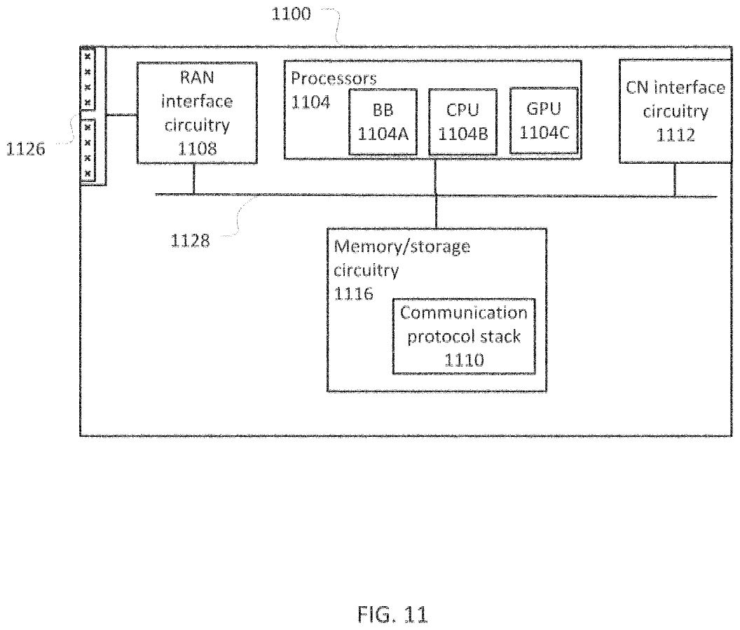

FIG. 11 illustrates a network node 1100 in accordance with some embodiments. The network node 1100 may be similar to and substantially interchangeable with base station 108 or another device of RAN 106.

The network node 1100 may include processors 1104, RF interface circuitry 1108 (if implemented as an access node), core network (CN) interface circuitry 1112, memory/storage circuitry 1116, and antenna structure 1126.

The components of the network node 1100 may be coupled with various other components over one or more interconnects 1128.

The processors 1104, RF interface circuitry 1108, memory/storage 1116 (including communication protocol stack 1110), antenna structure 1126, and interconnects 1128 may be similar to like-named elements shown and described with respect to FIG. 10.

The memory/storage 1116 may include one or more non-transitory, computer-readable media that includes instructions (for example, communication protocol stack 1110) that may be executed by one or more of the processors 1104 to cause the network node 1100 to perform paging operations as described herein. For example, the processors 1104 may cause the network node 1100 to perform the operational flow/algorithmic structure 800 or any other method or process described herein.

The CN interface circuitry 1112 may provide connectivity to a core network, for example, a 5th Generation Core network (5GC) using a 5GC-compatible network interface protocol such as carrier Ethernet protocols, or some other suitable protocol. Network connectivity may be provided to/from the network node 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

In some embodiments, the network node 1100 may be coupled with transmit receive points (TRPs) using the antenna structure 1126, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes a method of operating a base station, the method comprising: identifying a core network (CN) extended discontinuous reception (eDRX) paging configuration that defines a first plurality of paging hyperframes (PHs); generating a radio access network (RAN) eDRX paging configuration that defines a second plurality of PHs, wherein a first PH of the first plurality of PHs overlaps with a second PH of the second plurality of PHs; and transmitting the RAN eDRX paging configuration to a user equipment (UE).

Example 2 includes the method of example 1 or some other example herein, wherein the second plurality of PHs comprises hyper-system frame numbers (H-SFNs) defined by: H-SFN mod T_{eDRX_RAN}=(UE_{ID_H} mod T_{eDRX_RAN}), where T_{eDRX_RAN} is an eDRX cycle of the RAN eDRX paging configuration and UE_{ID_H} is a predetermined number of most significant bits of a hashed identifier of the UE.

Example 3 includes the method of example 2 or some other example herein, wherein the predetermined number is 13 and the eDRX cycle of the RAN paging configuration is 2, 4, 8, 16, 32, 64, 128, 256, 512, or 1024 hyper-frames.

Example 4 includes the method of example 1, wherein an eDRX cycle of the RAN eDRX paging configuration is less than or equal to an eDRX cycle of the CN eDRX paging configuration.

Example 5 includes the method of example 4 or some other example herein, further comprising: receiving the CN eDRX paging configuration in a UE paging information message; and selecting the eDRX cycle based on the CN eDRX paging configuration.

Example 6 includes the method of example 1 or some other example herein, wherein: a first paging time window (PTW) of the first PH has a first plurality of eDRX paging occasions (POs); a second PTW of the second PH has a second plurality of eDRX POs, a first set of the second plurality of eDRX POs overlap with the first plurality of eDRX POs, a second set of the second plurality of eDRX POs occur after the first PTW and do not overlap with the first plurality of eDRX POs; and the method further comprises: buffering a CN paging message and providing the CN paging message to the UE in an eDRX PO of the first set of the second plurality of eDRX POs.

Example 7 includes the method of example 1 or some other example herein, wherein PTWstart is a system frame number (SFN) of a radio frame at a start of the second PH, and the SFN is given by: SFN=128*i_{eDRX_RAN}, where i_{eDRX_RAN}=floor (UE_{ID_H}/T_{eDRX_CN}) mod 8, where UE_{ID_H} is a predetermined number of most significant bits of a hashed identifier of the UE and T_{eDRX_CN} is an eDRX cycle of the CN eDRX paging configuration.

Example 8 includes the method of example 1 or some other example herein, wherein PTWstart is a system frame number (SFN) of a radio frame at a start of a third PH of the second plurality of PHs, the third PH does not overlap with any of the first plurality of PHs, and SFN is given by: SFN=1024/N*i_{eDRX_RAN}, where i_{eDRX_RAN}=floor (UE_{ID_H}/T_{eDRX_RAN}) mod N, where UE_{ID_H} is a predetermined number of most significant bits of a hashed identifier of the UE, N is a number of available UE-specific paging distributions, and T_{eDRX_RAN} is an eDRX cycle of the RAN eDRX paging configuration.

Example 9 includes the method of example 8 or some other example herein, wherein N is 8, 16, or 32.

Example 10 includes the method of operating a user equipment (UE), the method comprising: identifying a core network (CN) extended discontinuous reception (eDRX) paging configuration that defines a first plurality of paging hyperframes (PHs); identifying a radio access network (RAN) eDRX paging configuration that defines a second plurality of PHs, wherein a first PH of the first plurality of PHs overlaps with a second PH of the second plurality of PHs; and monitoring, while in an inactive state, for a RAN paging message in the second PH.

Example 11 includes the method of example 10 or some other example herein, wherein the second plurality of PHs comprises hyper-system frame numbers (H-SFNs) defined by: H-SFN mod T_{eDRX_RAN}=(UE_{ID_H} mod T_{eDRX_RAN}), where T_{eDRX_RAN} is an eDRX cycle of the RAN eDRX paging configuration and UE_{ID_H} is a predetermined number of most significant bits of a hashed identifier of the UE.

Example 12 includes the method of example 11 or some other example herein, wherein the predetermined number is 13 and the eDRX cycle of the RAN eDRX paging configuration is 2, 4, 8, 16, 32, 64, 128, 256, 512, or 1024 hyper-frames.

Example 13 includes the method of example 10 or some other example herein, wherein an eDRX cycle of the RAN eDRX paging configuration is less than or equal to an eDRX cycle of the CN eDRX paging configuration.

Example 14 includes the method of example 10 or some other example herein, further comprising: identifying paging time windows (PTWs) based on the RAN eDRX paging configuration; monitoring for RAN paging messages within the PTWs; and refraining from monitoring for RAN paging messages outside of the PTWs.

Example 15 includes the method of example 10 or some other example herein, further comprising: identifying a first paging time window (PTW) of the first PH, the first PTW starting at a first point, ending at a second point, and having a first plurality of eDRX paging occasions (POs); and identifying a second PTW of the second PH, the second PTW starting at the first point, ending at a third point, and having a second plurality of eDRX POs.

Example 16 includes the method of example 15 or some other example herein, wherein the third point occurs later in time than the second point and the method further comprises: monitoring for RAN paging messages and CN paging messages in the second plurality of eDRX POs.

Example 17 includes the method of example 15 or some other example herein, wherein the second point occurs later in time than the third point, a first set of the first plurality of eDRX POs overlap with the second plurality of eDRX POs, a second set of the first plurality of eDRX POs do not overlap with the first plurality of eDRX POs and the method further comprises: monitoring for RAN paging messages in the first set of the first plurality of eDRX POs; and either monitoring for CN paging messages in the second set of the first plurality of eDRX POs or not monitoring for CN paging messages in the second set of the first plurality of eDRX POs.

Example 18 includes the method of example 15 or some other example herein, wherein a first radio frame at the third point has a first system frame number (SFN1) given by: SFN1=(PTWstart+L*100−1) mod 1024, wherein PTWstart is a second SFN (SFN2) of a second radio frame at the first point and L is given by: L=max{a length of the first PTW; a length of the second PTW}; or L=a length of the second PTW.

Example 19 includes the method of example 15 or some other example herein, wherein PTWstart is a system frame number (SFN) of a radio frame at the first point and is given by: SFN=128*i_{eDRX_RAN}, where i_{eDRX_RAN}=floor (UE_{ID_H}/T_{eDRX_CN}) mod 8, where UE_{ID_H} is a predetermined number of most significant bits of a hashed identifier of the UE and T_{eDRX_CN} is an extended discontinuous reception (eDRX) cycle of the CN eDRX paging configuration.

Example 20 includes the method of example 15 or some other example herein, wherein PTWstart is a system frame number (SFN) of a radio frame at a start of a third PH of the second plurality of PHs, the third PH does not overlap with any of the first plurality of PHs, and the SFN is given by: SFN=128*i_{eDRX_RAN}, where i_{eDRX_RAN}=floor (UE_{ID_H}/T_{eDRX_RAN}) mod 8, where UE_{ID_H} is a predetermined number of most significant bits of a hashed identifier of the UE and T_{eDRX_RAN} is an extended discontinuous reception (eDRX) cycle of the RAN paging configuration.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
identifying a core network (CN) extended discontinuous reception (eDRX) paging configuration that defines a first plurality of paging hyperframes (PHs); and
generating, for transmission to a user equipment (UE), a radio access network (RAN) eDRX paging configuration that defines a second plurality of PHs, wherein a first PH of the first plurality of PHs overlaps with a second PH of the second plurality of PHs.

22. The method of claim 21, wherein the second plurality of PHs comprises hyper-system frame numbers (H-SFNs) defined by:
$$H - SFN mod {T}_{eDRX \_ RAN} = ( {UE}_{ID \_ H} mod {T}_{eDRX \_ RAN} ) ,$$
where T_{eDRX_RAN} is an eDRX cycle of the RAN eDRX paging configuration and UE_{ID_H} is a predetermined number of most significant bits of a hashed identifier of the UE.

23. The method of claim 22, wherein the predetermined number is 13 and the eDRX cycle of the RAN paging configuration is 2, 4, 8, 16, 32, 64, 128, 256, 512, or 1024 hyper-frames.

24. The method of claim 21, wherein an eDRX cycle of the RAN eDRX paging configuration is less than or equal to an eDRX cycle of the CN eDRX paging configuration.

25. The method of claim 24, further comprising:
receiving the CN eDRX paging configuration in a UE paging information message; and
selecting the eDRX cycle based on the CN eDRX paging configuration.

26. The method of claim 21, wherein: a first paging time window (PTW) of the first PH has a first plurality of eDRX paging occasions (POs); a second PTW of the second PH has a second plurality of eDRX POs, a first set of the second plurality of eDRX POs overlap with the first plurality of eDRX POs, a second set of the second plurality of eDRX POs occur after the first PTW and do not overlap with the first plurality of eDRX POs; and the method further comprises:
buffering a CN paging message and providing the CN paging message to the UE in an eDRX PO of the first set of the second plurality of eDRX POs.

27. The method of claim 21, wherein PTWₛₜₐᵣₜ is a system frame number (SFN) of a radio frame at a start of the second PH, and the SFN is given by:
$$SFN = 128 * {i}_{eDRX \_ RAN} ,$$
$$where {i}_{eDRX \_ RAN} = floor ( {UE}_{ID \_ H} / {T}_{eDRX \_ CN} ) mod 8 ,$$
where UE_{ID_H} is a predetermined number of most significant bits of a hashed identifier of the UE and T_{eDRX_CN} is an eDRX cycle of the CN eDRX paging configuration.

28. The method of claim 21, wherein PTWₛₜₐᵣₜ is a system frame number (SFN) of a radio frame at a start of a third PH of the second plurality of PHs, the third PH does not overlap with any of the first plurality of PHs, and SFN is given by:
$$SFN = 1024 / N * {i}_{eDRX \_ RAN} ,$$
$$where {i}_{eDRX \_ RAN} = floor ( {UE}_{ID \_ H} / {T}_{eDRX \_ RAN} ) mod N ,$$
where UE_{ID_H} is a predetermined number of most significant bits of a hashed identifier of the UE, N is a number of available UE-specific paging distributions, and T_{eDRX_RAN} is an eDRX cycle of the RAN eDRX paging configuration.

29. The method of claim 28, wherein N is 8, 16, or 32.

30. At least one non-transitory, computer-readable media having instructions that, when executed, cause processor circuitry to:
identify a core network (CN) extended discontinuous reception (eDRX) paging configuration that defines a first plurality of paging hyperframes (PHs);
identify a radio access network (RAN) eDRX paging configuration that defines a second plurality of PHs, wherein a first PH of the first plurality of PHs overlaps with a second PH of the second plurality of PHs; and
monitor, while in an inactive state, for a RAN paging message in the second PH.

31. The at least one non-transitory, computer-readable media of claim 30, wherein the instructions, when executed, further cause the processor circuitry to:
identify a first paging time window (PTW) of the first PH, the first PTW starting at a first point, ending at a second point, and having a first plurality of eDRX paging occasions (POs); and
identify a second PTW of the second PH, the second PTW starting at the first point, ending at a third point, and having a second plurality of eDRX POs.

32. The at least one non-transitory, computer-readable media of claim 31, wherein the third point occurs later in time than the second point and the instructions, when executed, further cause the processor circuitry to:
monitor for RAN paging messages and CN paging messages in the second plurality of eDRX POs.

33. The at least one non-transitory, computer-readable media of claim 31, wherein the second point occurs later in time than the third point, a first set of the first plurality of eDRX POs overlap with the second plurality of eDRX POs, a second set of the first plurality of eDRX POs do not overlap with the first plurality of eDRX POs and the instructions, when executed, further cause the processor circuitry to:
monitor for RAN paging messages in the first set of the first plurality of eDRX POs; and
either monitor for CN paging messages in the second set of the first plurality of eDRX POs or not monitor for CN paging messages in the second set of the first plurality of eDRX POs.

34. The at least one non-transitory, computer-readable media of claim 31, wherein a first radio frame at the third point has a first system frame number (SFN₁) given by:
$$S F {N}_{1} = ( P T {W}_{start} + L * 100 - 1 ) mod 1024 ,$$
wherein PTWₛₜₐᵣₜ is a second SFN (SFN2) of a second radio frame at the first point and L is given by:
$$L = max \{ a length of the first PTW ; a length of the second PTW \} ; or$$
$$L = a length of the second PTW .$$

35. The at least one non-transitory, computer-readable media of claim 31, wherein PTWₛₜₐᵣₜ is a system frame number (SFN) of a radio frame at the first point and is given by:
$$SFN = 128 * {i}_{eDRX \_ RAN} ,$$
$$where {i}_{eDRX \_ RAN} = floor ( {UE}_{ID \_ H} / {T}_{eDRX \_ CN} ) mod 8 ,$$
where UE_{ID_H} is a predetermined number of most significant bits of a hashed identifier of the UE and T_{eDRX_CN} is an extended discontinuous reception (eDRX) cycle of the CN eDRX paging configuration.

36. The at least one non-transitory, computer-readable media of claim 31, wherein PTWₛₜₐᵣₜ is a system frame number (SFN) of a radio frame at a start of a third PH of the second plurality of PHs, the third PH does not overlap with any of the first plurality of PHs, and the SFN is given by:
$$SFN = 128 * {i}_{eDRX \_ RAN} ,$$
$$where {i}_{eDRX \_ RAN} = floor ( {UE}_{ID \_ H} / {T}_{eDRX \_ RAN} ) mod 8 ,$$
where UE_{ID_H} is a predetermined number of most significant bits of a hashed identifier of the UE and T_{eDRX_RAN} is an extended discontinuous reception (eDRX) cycle of the RAN paging configuration.

37. A method comprising:
identifying a core network (CN) extended discontinuous reception (eDRX) paging configuration that defines a first plurality of paging hyperframes (PHs);
identifying a radio access network (RAN) eDRX paging configuration that defines a second plurality of PHs, wherein a first PH of the first plurality of PHs overlaps with a second PH of the second plurality of PHs; and
monitoring, while in an inactive state, for a RAN paging message in the second PH.

38. The method of claim 37, wherein the second plurality of PHs comprises hyper-system frame numbers (H-SFNs) defined by:
$$H - SFN mod {T}_{eDRX \_ RAN} = ( {UE}_{ID \_ H} mod {T}_{eDRX \_ RAN} ) ,$$
where T_{eDRX_RAN} is an eDRX cycle of the RAN eDRX paging configuration and UE_{ID_H} is a predetermined number of most significant bits of a hashed identifier of the UE,
wherein the predetermined number is 13 and the eDRX cycle of the RAN eDRX paging configuration is 2, 4, 8, 16, 32, 64, 128, 256, 512, or 1024 hyper-frames.

39. The method of claim 37, wherein an eDRX cycle of the RAN eDRX paging configuration is less than or equal to an eDRX cycle of the CN eDRX paging configuration.

40. The method of claim 37, wherein the processor circuitry is to:
identify paging time windows (PTWs) based on the RAN eDRX paging configuration;
monitor for RAN paging messages within the PTWs; and
refrain from monitoring for RAN paging messages outside of the PTWs.
